(19) United States
(12) Patent Application Publication
(10) Pub. No.: US 2018/0363362 A1
(43) Pub. Date: Dec. 20, 2018

(54) DROP-DOWN SEAL

(71) Applicant: Planet GDZ AG

(72) Inventor: Andreas DINTHEER, Illnau (CH)

(21) Appl. No.: 15/741,349

(22) PCT Filed: Jun. 20, 2016
(86) PCT No.: PCT/EP2016/064183

§ 371 Date: Jan. 2, 2018

(30) Foreign Application Priority Data
Jul. 1, 2015 (EP) 15 174 841.5

(51) Int. Cl. E06B 7/215

(52) U.S. Cl. CPC E06B 7/215

(57) ABSTRACT

A drop-down seal having a housing rail, a support rail, a seal profile, a lowering mechanism, and a through-opening, through which a locking bar can pass. The support rail has a base rail and an expansion device which adjoins the base rail in the longitudinal direction of the drop-down seal. The through-opening runs along or through the expansion device and has an inner width over the entire height of the expansion device, said width being greater than the inner width of the base rail or alternatively or in addition thereto corresponding at least to the outer width of the base rail. The base rail, the expansion device, and the seal profile can be lifted and lowered together by the lowering mechanism.

### TECHNICAL FIELD

The present invention relates to a drop-down seal for a door without a sill for sealing a gap between a door leaf and a floor.

### PRIOR ART

Sealing devices which are able to be automatically and mechanically lowered are known. Said sealing devices are generally used for doors without sills in order to seal the lower gap between the door leaf and the floor against drafts, sound and light penetration. A seal as disclosed, for example, in EP 0 338 974 has proved expedient. In this case, the sealing device is actuated automatically when the door is opened and closed. Examples of corresponding lowering mechanisms are disclosed in EP 0 509 961, DE 19 516 530, DE 3 526 720, DE 3 418 438 and DE 3 427 938. In this case, the drop-down seal is actuated on one side or on both sides, but generally on the front side, by a spring-loaded release bolt being pushed in when the door is closed, said spring-loaded release bolt protruding from the door leaf. Other types of release mechanisms are also known.

Moreover, it is disclosed in EP 1 191 182 and EP 1 308 590 to provide such seals with a through-opening which serves for receiving a locking bolt or locking bar. The bar in this case penetrates a housing rail and a sealing strip of the drop-down seal. As a result, the entire width of the door may be sealed, even when using such a locking bar, wherein the bolt may be actuated independently of the lowering mechanism of the sealing strip.

EP 2 050 918 discloses a drop-down seal with such a through-opening which has regions which are able to be shortened and which are not passed through by the lowering mechanism.

IT 1392997 VI discloses a drop-down seal with a separate end piece with a through-opening and a sealing lip, wherein the end piece has to be manually lowered.

DE 20 2014 100 774 U discloses a bar guide plate which is screwed onto the lower front face of the door leaf, so that the through-opening of the housing rail does not have to serve at the same time as a guide for the locking bar.

In the known devices, however, the width of the housing rail limits the diameter of the locking bar and/or the locking bolt. In other words, in the case of narrow seals, in order to be sufficiently stable the bar and/or the bolt has to have either a rectangular cross section or the seal has to be used with a weakened bar having a reduced cross section.

### SUMMARY OF THE INVENTION

It is the object of the invention, therefore, to provide a drop-down seal which may also be used with relatively thick locking bars and/or bolts.

The drop-down seal according to the invention for a door without a sill, for sealing a gap between a door leaf and a floor, has a housing rail, a support rail, a seal profile and a lowering mechanism, wherein the seal profile is arranged, in particular is held, on the support rail. The support rail is able to be lifted and lowered together with the seal profile relative to the housing rail by means of the lowering mechanism. The drop-down seal has a through-opening which runs transversely to the longitudinal direction of the drop-down seal and parallel to the lowering and lifting direction and through which a locking bar can pass. The support rail has a base rail and an expansion means which adjoins the base rail in the longitudinal direction of the drop-down seal, wherein the through-opening runs along the expansion means and/or through the expansion means and over the entire height of the expansion means has an inner width which is greater than the inner width of the base rail or alternatively or in addition thereto which corresponds at least to the outer width of the base rail. The inner widths and the outer width extend in this case perpendicularly to the longitudinal direction and perpendicularly to the lowering and lifting direction. According to the invention the base rail, the expansion means and the seal profile may be lifted and lowered together by means of the lowering mechanism.

In this text, the term “locking bar” and/or “bar” is used. Locking bolts or other elongated structures which are suitable for passing through the drop-down seal and for producing a locking in the direction of the floor, for example by engaging in a floor recess, are also encompassed thereby. The bar may, in particular, be part of a drive bolt which is connected to the door handle or a flush bolt which is actuated separately.

Due to the through-opening of wider design and preferably due to the expansion means of wider design, the drop-down seal according to the invention permits the use of wider bars than in the prior art. For example, in the case of the same cross section of the drop-down seal, bars may be used which have a diameter which is larger by 1 to 2 mm than the bars previously used.

In a first embodiment, only the inner width of the expansion means is wider than the internal dimension of the housing rail. In other embodiments, the external dimension is also wider and at least partially fills the clearance which the support rail normally has in the housing rail.

It is advantageous in the solution according to the invention that the expansion may be implemented within the housing rail. In other words, the drop-down seal and/or the housing rail may have the same cross section as the known seals. The housing rail extends in one piece over the entire length and thereby protects the internal parts.

It is also advantageous that the bar does not have to be guided by the base rail of the support rail, so that it may be configured in any manner. If the inner face of the expansion means is configured in a planar manner, the expansion means slides practically without resistance along the bar and vice versa and the relative movement of the bar and support rail relative to one another is not hindered. A specific guidance as in DE 20 2014 100 774 U is superfluous.

Preferably, the seal profile extends over the entire length of the base rail and the expansion means.

Preferably, the expansion means is arranged, in particular held, on the base rail and fixed relative thereto. As a result, the assembly of the seal is simplified and the common movement is ensured when lowering and lifting. Moreover, the support rail which is already known from the prior art and mentioned above may be used as a base rail; in other words, it may have this profile shape.

The seal profile generally consists of an elastomer material. Preferably, it is integrally formed or fastened on the base rail. As a result, the seal profile is connected practically over the entire length of the seal to the support rail. In this case, it preferably extends at least over the entire length of the housing rail. Depending on the embodiment, said seal profile even protrudes on one side or both sides of the housing rail in the longitudinal direction.

Preferably, however, the seal profile is not fastened directly to the expansion means but extends loosely in this region. As a result, the side walls of the expansion means may be designed to be very thin.

Preferably, the seal profile has two upwardly oriented limbs which bear slidingly and sealingly against the internal walls of the housing rail. Preferably, the limbs extend over the entire length of the seal profile, in other words, also along the expansion means.

Preferably, the seal profile is configured in one piece or consists of a plurality of parts connected fixedly together. These parts are, for example, bonded together or welded together.

Preferably, the expansion means does not form the end of the drop-down seal but a further end piece, which adjoins the expansion means at the end of the expansion means remote from the base rail, is present. In this case, the seal profile preferably also extends over the entire length of the end piece. The end piece is able to be lifted and lowered together with the base rail, the expansion means and the seal profile by means of the lowering mechanism. Thus the expansion means forms an interruption in the support rail. The end piece and the base rail are preferably of the same configuration and the seal profile is preferably integrally formed or held on the base rail and on the end piece. Preferably, the seal profile extends without interruption over the entire base rail, the expansion means and the end piece.

Preferably, the expansion means is arranged, in particular held, on the end piece and fixed relative thereto. As a result, the expansion means may be fastened at one end to the base rail and at the other end to the end piece. Thus it forms a bridge between the base rail and the end piece.

Preferably, the base rail and the end piece are configured equally in their cross section. The end piece is thus preferably also produced from the profiles of the support rail known from the prior art.

The base rail, the end piece and the expansion means preferably form together the support rail which preferably does not protrude from the housing rail on both sides but preferably has the same length or is slightly shorter.

So that the bar does not hinder the lowering procedure, the mechanical lowering mechanism preferably merely extends along the base rail and preferably terminates at a distance from the expansion means.

The expansion means may be configured in any manner, as long as it permits a through-opening with a greater inner width than might be permitted by the remaining support rail. In a preferred embodiment, the expansion means comprises two plates. These plates are preferably bent outwardly. Preferably at least one of the plates, preferably both plates, are configured to be narrow in comparison with the wall thickness of the base rail.

The plates are preferably fastened to side walls of the base rail and, if present, of the end piece, said side walls extending vertically opposite one another in the use state. The fastening to the base rail and to the end piece preferably takes place by means of one respective rivet pin or bolt which is driven through the two opposing side walls of the base rail and the end piece, respectively, and as a result fixes the side leaves bearing internally against the side walls.

At least one of the two plates, preferably both plates, have a wall thickness which is less than the corresponding wall thicknesses of the base rail.

In a preferred embodiment, the expansion means consists of these two plates.

Preferably, each plate comprises a base plate which at opposing ends transitions into one respective side leaf, wherein an angled leaf is arranged on one of the two side leaves. Preferably, the base plate is bent outwardly. The bending of the base plate may be continuous, i.e. arcuate. However, it may also be implemented in one or more steps. The side leaves are preferably configured to be planar.

Preferably, a front face of the base rail forms a front-face lower stop for the base plates, wherein the base plates protrude downwardly from the side leaves. As a result, the plates may not be displaced in the longitudinal direction relative to the base rail. Preferably, the end piece also forms such a stop so that a displacement relative to the end piece is also not possible. These stops form an anti-rotational locking of the rivet connection.

Preferably, the angled leaf in the lower region has a shape which forms a counterpart to a region of the inner face of the base rail and, if present, of the end piece, so that the connection between the angled leaf and this region forms a further anti-rotational locking.

Preferably, the two plates are of identical configuration. In one embodiment, said plates are two parts which are separate from one another and which are arranged mirror-symmetrically to one another so that the one angled leaf is arranged in the end piece and the other angled leaf is arranged in the base rail.

In a further embodiment, the two plates are both configured in one piece, with one respective base plate and two respective side leaves, wherein the common angled leaf forms the connecting piece between the two plates. At the open end of the expansion means, i.e. at the end opposing the angled leaf or connecting web, a spacer, for example a spacer sleeve, may be clamped into the side walls of the support rail.

### BRIEF DESCRIPTION OF THE DRAWINGS

Preferred embodiments of the invention are disclosed hereinafter with reference to the drawings which merely serve for explanation and are not to be understood as limiting. In the drawings:

FIG. 1 shows a perspective view of a drop-down seal according to the invention with the bar passing through said seal;

FIG. 2 shows a perspective view of a support rail of the drop-down seal according to FIG. 1 and the bar passing through said support rail;

FIG. 3 shows a longitudinal section through the drop-down seal according to FIG. 1 with the lifted support rail and seal profile;

FIG. 4 shows a view of the drop-down seal according to FIG. 1 from the front with the lifted support rail and seal profile;

FIG. 5 shows a longitudinal section through the drop-down seal according to FIG. 1 with the lowered support rail and seal profile;

FIG. 6 shows a view of the drop-down seal according to FIG. 1 from the front with the lowered support rail and seal profile;

FIG. 7 shows a view of the support rail with the bar according to FIG. 2 from above;

FIG. 8 shows an enlarged detail of FIG. 7;

FIG. 9 shows a perspective view of a plate of an expansion means according to the invention in a first embodiment;

FIG. 10 shows a view of the plate according to FIG. 9 from the front;

FIG. 11 shows a view of the plate according to FIG. 9 from the top;

FIG. 12 shows a view of the plate according to FIG. 9 from the side;

FIG. 13 shows a view of a plate of an expansion means according to the invention from the front in a second embodiment;

FIG. 14 shows a view of the plate according to FIG. 13 from above;

FIG. 15 shows a view of the plate according to FIG. 13 from the side;

FIG. 16 shows a view of a plate of an expansion means according to the invention from the front in a third embodiment;

FIG. 17 shows a view of the plate according to FIG. 16 from above and

FIG. 18 shows a view of the plate according to FIG. 16 from the side.

### DESCRIPTION OF PREFERRED EMBODIMENTS

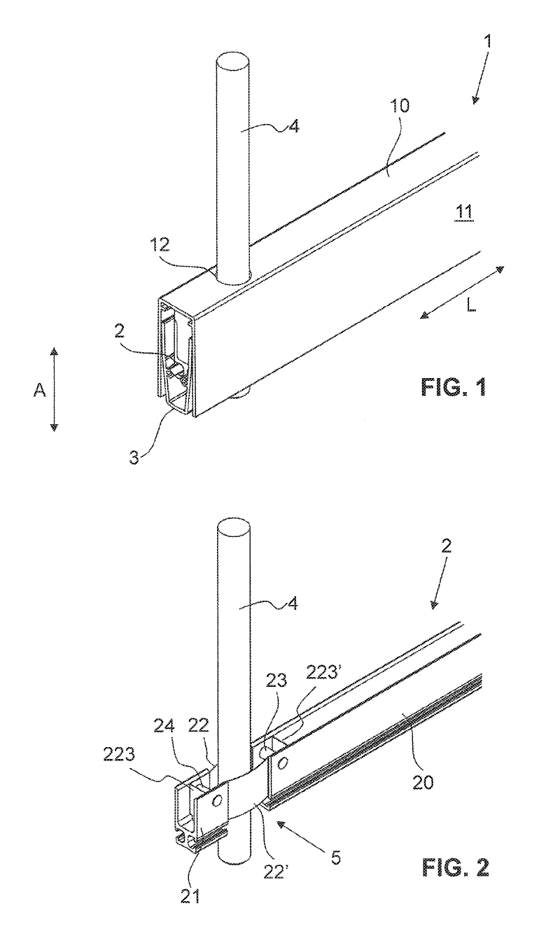

FIG. 1 shows a drop-down seal according to the invention which is passed through by a bar 4 or a bolt of a flush bolt or drive bolt. The bar 4 is movable relative to the drop-down seal in the direction A. In other words, the bar 4 and also the drop-down seal may be lifted and lowered independently of one another.

The drop-down seal has a housing rail 1 in which a sealing strip is held so as to be able to be lifted and lowered in the direction A. The sealing strip comprises a support rail 2 and an elastomer seal profile 3 fastened thereto. The housing rail 1 and the support rail 2 are preferably made of metal, in particular of aluminum. A mechanical lowering mechanism of the known type, and not visible, is arranged in the substantially U-shaped housing rail 1 which is configured to be open downwardly, said lowering mechanism terminating at the end of the drop-down seal on the front face, not shown, in an actuating knob of the known type which protrudes from the housing rail 1 and which is pushed in when the door leaf is closed and thus actuates the lowering mechanism. Other types of mechanical lowering mechanisms and release elements may also be used.

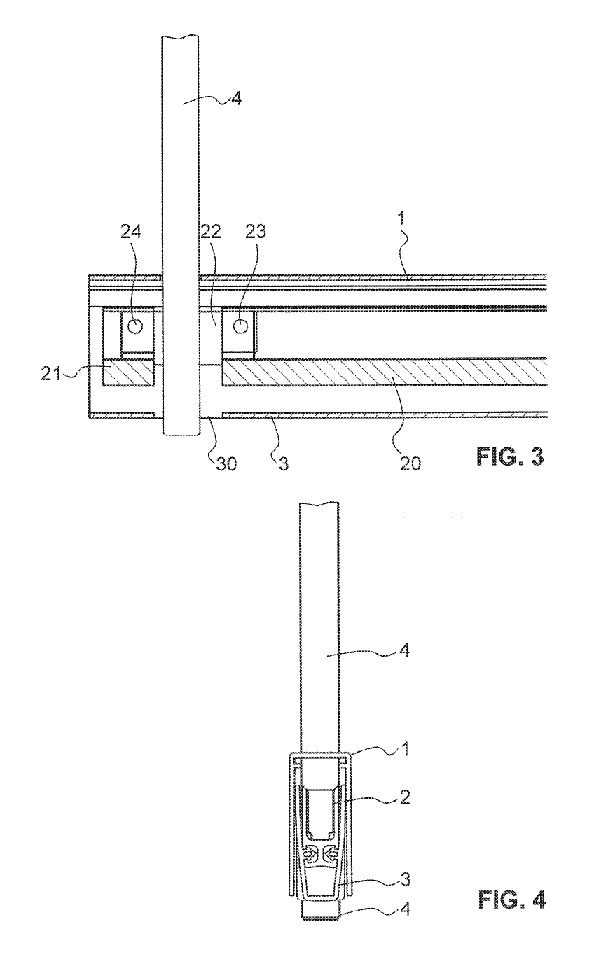

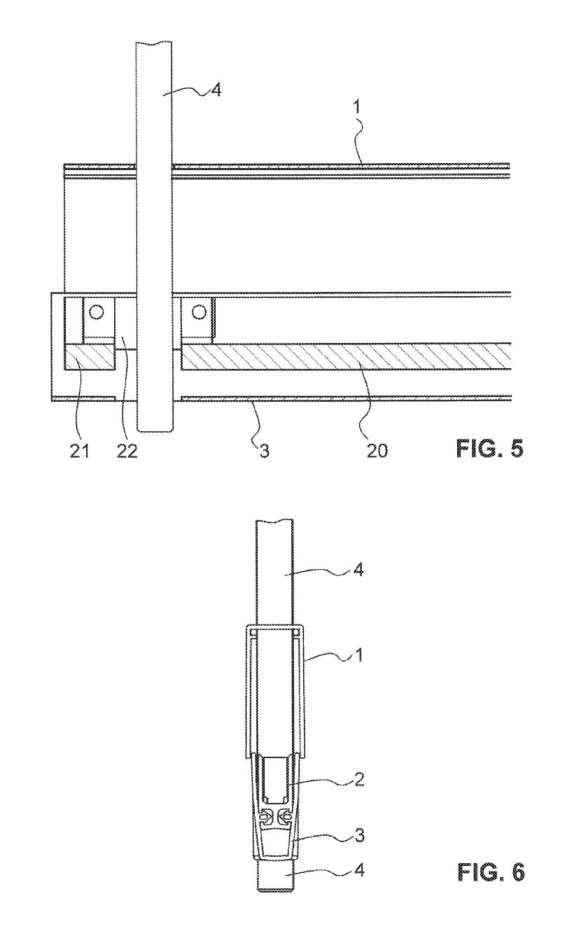

In the lifted state according to FIG. 1, the sealing strip 2, 3 is received between the side walls 11 of the housing rail 1. A through-opening 12 is present in the housing rail 1 in the upper web, in an end region on the front face. The through-opening 12 is preferably circular. It may, however, also have a different shape. It may, in particular, be oval or rectangular. This through-opening 12 is passed through by the bar 4. As may be identified in FIGS. 3 to 6, the seal profile 3 also has a corresponding through-opening 30. The through-opening 12 in the housing rail 1 is preferably dimensioned such that it guides the bar 4; i.e. it is insignificantly larger than the diameter of the bar 4. The through-opening 30 in the seal profile 3 is preferably configured as a slot, wherein the slot in the transverse direction is insignificantly larger than the bar diameter. As a result, the seal is ensured.

The support rail 2 in the region of the bar 4, however, does not simply have a through-opening. The support rail 2 in this region is configured instead as an expansion means 5.

As is clearly visible in FIG. 2, the support rail 2 has a base rail 20 which is configured in the known manner from an upwardly open, substantially U-shaped profiled rail. It has a lower region which serves for fastening the seal profile 3. This base rail 20 extends over approximately the entire length of the housing rail 1 until it is in the vicinity of the through-opening 12. The base rail 20 is connected to the mechanical lowering mechanism and to the housing rail 1 thereby. The lowering mechanism, except for any release elements, preferably extends only in the base rail 20 and terminates at a distance from the expansion means 5.

The expansion means 5 adjoins the base rail 20. In this example, it is fastened by a first fastening element 23, in this case by a first rivet pin, to the internal walls of the base rail 20.

An end piece 21 adjoins the opposing end of the expansion means 5. In terms of shape, this end piece is configured identically to the base rail 20 but substantially shorter. It also preferably consists of metal, in particular aluminum, in the manner of the base rail. The expansion means 5 is also fastened to the inner walls of this end piece 21 by means of a second fastening element 24, in this case by means of a second rivet pin.

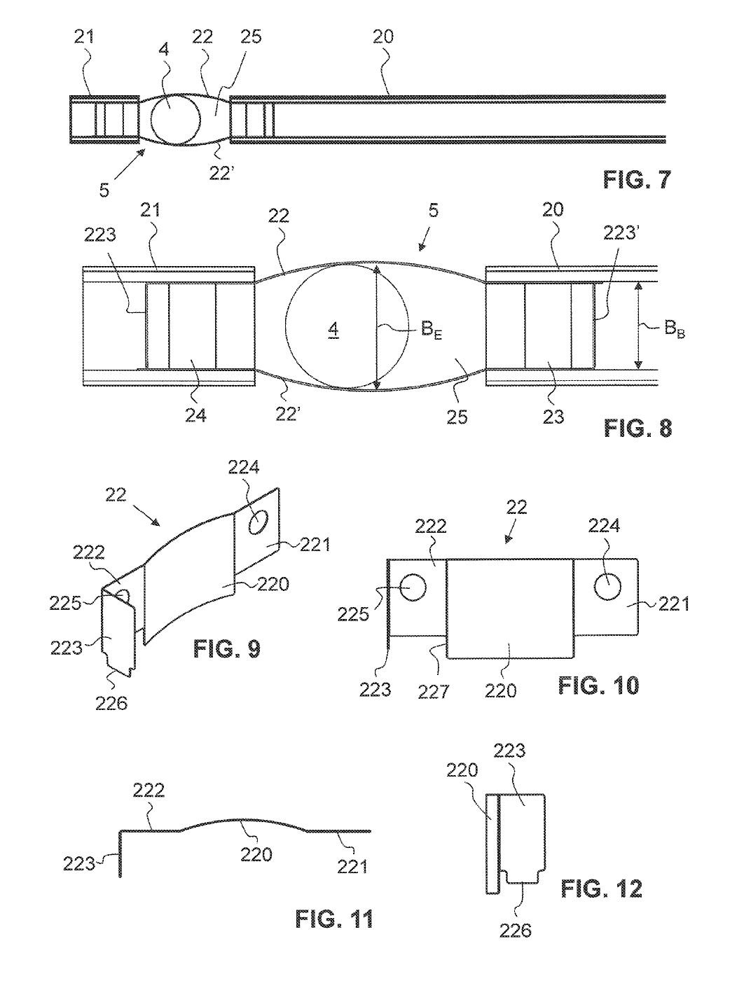

As is clearly visible in FIGS. 7 and 8, the expansion means 5 has a through-opening 25 with a greater inner width B_{E} than the adjacent base rail 20 and also than the adjacent end piece 21. The inner width of the base rail 20 is specified in FIG. 8 by B_{B}. Thus a bar 4 may be used with a diameter which is greater than the remaining support rail 2 might permit.

The seal profile 3 is fastened to the base rail 20 and to the end piece 21 but not to the expansion means 5. Said seal profile extends, however, over the entire length L of the seal, i.e. also along the region of the expansion means 5.

Due to the rigid and stiff connection of the base rail 20, the expansion means 21 and the end piece 22, these three parts together with the seal profile may be lowered and lifted by means of the same lowering mechanism, although the mechanism is only connected to the base rail 20 and not to the remaining elements of the sealing strip.

In FIGS. 9 to 12 it may be identified how the expansion means 5 in the first embodiment according to FIGS. 1 to 8 is configured. The expansion means 5 consists of two plates 22, one thereof being shown in FIGS. 9 to 12. The other plate 22 is preferably of identical configuration but rotated by 180° in the seal.

At least one of the plates 22, preferably both plates 22, are configured to be very narrow and thin, respectively. They are, in particular, substantially thinner than the side walls of the base rail 20. The plates preferably consist of a metal or plastics. Preferably they consist of steel. They are preferably configured to be stiff, not resilient.

The plate 22 has a base body 220 which is bent outwardly. Here the curvature is continuous. Side leaves 221, 222 adjoin both sides of the base body 220, and are provided with one respective fastening opening 224, 225. These fastening openings are passed through by the respective rivet pin 23, 24. An angled leaf 223 adjoins one of the side leaves 222. The angle is preferably 90°. This angled leaf 223 serves as a spacer when the plate 22 is inserted between the base rail 20 and the end piece 21. The length of the leaf 223 preferably corresponds to the inner width of the receiving part, i.e. of the base rail 20 or of the end piece 21.

The angled leaf 223 has in the lower region a tapering 226 which corresponds to the internal profile of the end piece 21 and the base rail 20, respectively. As a result, the angled leaf 223 fits positively in this cavity and thus forms an anti-rotational locking.

A further anti-rotational locking is ensured by the base body 220 having an edge 227 which protrudes in comparison with the side leaves 221, 222. This edge 227 bears against the lower front face of the base rail 20 and the end piece 21, respectively. It additionally serves to maintain the distance between the end piece 21 and the base rail.

As may be identified in FIG. 8, the opposing second plate 22′ of the expansion means is arranged such that its angled leaf 223′ is arranged in the base rail 20, wherein the angled leaf 223 of the first plate 20 is located in the end piece 21.

The internal and external walls of the base body 220, 220′ are preferably of smooth configuration. As a result, the expansion means 5 may be moved in a virtually frictionless manner relative to the bar 4.

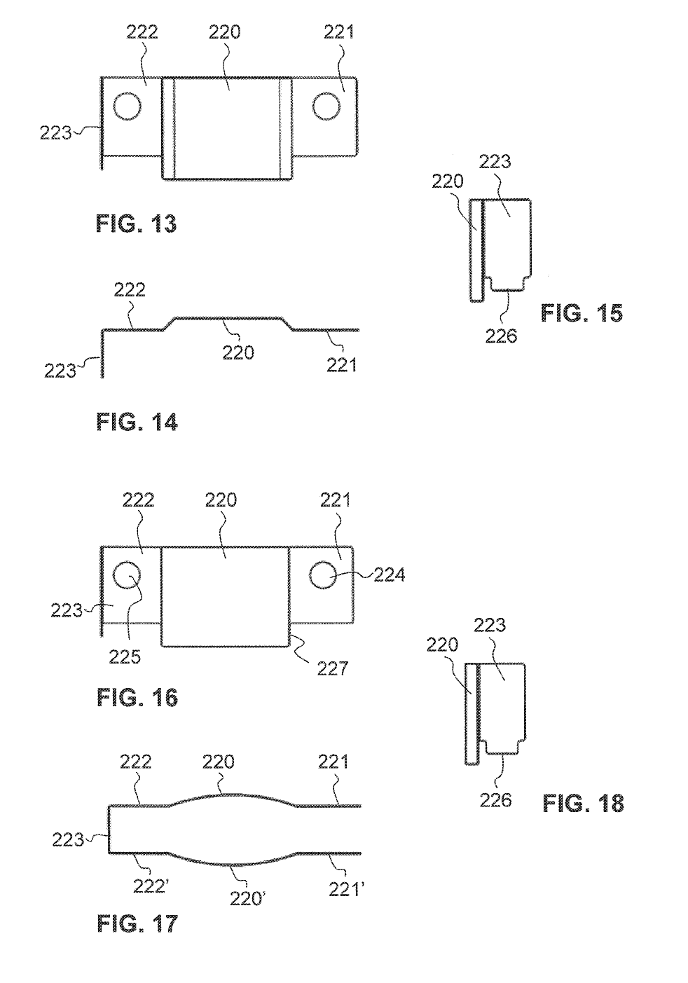

In FIGS. 13 to 15, a second exemplary embodiment of a plate 22 of the expansion means 5 is shown. Also in this case two plates 22 which are identically configured but arranged mirror-symmetrically to one another form the expansion means 5. The plate 22 is configured in a virtually identical manner to the already described plate. The base plate 220, however, is stepped and not continuously bent outwardly.

In the exemplary embodiment according to FIGS. 16 to 18, the expansion means 5 is not formed by two separate plates but by a one-piece part which substantially consists of the two plates. An angled leaf 223 forms a connecting web between two side leaves 222, 222′. An angled leaf is not present on the opposing side but the side leaves 221, 221′ terminate unattached at that point. Depending on the embodiment, a spacer, for example a spacer sleeve, is clamped in this free end region.

The drop-down seal according to the invention with the divided support rail, therefore, may be used with relatively thick and, therefore, stable drive bolt bars or edge bolt bars.

### LIST OF REFERENCE NUMERALS

1 Housing rail

10 Upper web

11 Side wall

12 Through-opening

2 Support rail

20 Base rail

21 End piece

22 First plate

22′ Second plate

220 Base plate

220′ Mirror-symmetrical base plate

221 First side leaf

221′ Mirror-symmetrical first side leaf

222 Second side leaf

222′ Mirror-symmetrical second side leaf

223 Angled leaf

224 First fastening opening

225 Second fastening opening

226 Tapering

227 Protruding edge

23 First fastening element

24 Second fastening element

25 Through-opening

3 Seal profile

30 Through-opening

4 Locking bar

5 Expansion means

L Longitudinal direction of drop-down seal

A Lifting and lowering direction

B_{E} Inner width of expansion means

B_{B} Inner width of base rail

1. A drop-down seal for a door without a sill for sealing a gap between a door leaf and a floor, wherein the drop-down seal has a housing rail, a support rail, a seal profile and a lowering mechanism, wherein the seal profile is arranged on the support rail and the support rail is able to be lifted and lowered together with the seal profile by the lowering mechanism relative to the housing rail, and wherein the drop-down seal has a through-opening which runs transversely to the longitudinal direction of the drop-down seal and parallel to the lowering and lifting direction of the support rail and through which a locking bar can pass,
wherein
the support rail has a base rail and an expansion means which adjoins the base rail in the longitudinal direction of the drop-down seal,
wherein the through-opening runs at least one of along the expansion means and/or through the expansion means and over the entire height of the expansion means has an inner width which is greater than the inner width of the base rail or alternatively or in addition thereto which corresponds at least to the outer width of the base rail, wherein the inner widths and the outer width extend perpendicularly to the longitudinal direction and perpendicularly to the lowering and lifting direction, and
wherein the base rail, the expansion means and the seal profile can be lifted and lowered together by means of the lowering mechanism.

2. The drop-down seal as claimed in claim 1, wherein the seal profile extends approximately over the entire length of the base rail and of the expansion means.

3. The drop-down seal as claimed in claim 1, wherein the expansion means is arranged on the base rail and fixed relative thereto.

4. The drop-down seal as claimed in claim 1, wherein the seal profile is integrally formed or fastened on the base rail.

5. The drop-down seal as claimed in claim 1, wherein the seal profile extends loosely relative to the expansion means.

6. The drop-down seal as claimed in claim 1, wherein the seal profile is configured in one piece or consists of a plurality of parts connected fixedly together.

7. The drop-down seal as claimed in claim 1, wherein an end piece adjoins the expansion means at the end of the expansion means remote from the base rail, and wherein the end piece is able to be lifted and lowered together with the base rail, the expansion means and the seal profile by the lowering mechanism.

8. The drop-down seal as claimed in claim 7, wherein the expansion means is arranged on the end piece and fixed relative thereto.

9. The drop-down seal as claimed in claim 7, wherein the seal profile is integrally formed or fastened on the end piece.

10. The drop-down seal as claimed in claim 1, wherein the expansion means comprises two plates, wherein the plates are arranged on opposing sides of the base rail and, if present, of the end piece, and wherein at least one of the two plates has a wall thickness which is less than the wall thickness of the base rail.

11. The drop-down seal as claimed in claim 10, wherein each plate comprises a base plate which at opposing ends transitions into one respective side leaf, wherein an angled leaf is arranged on one of the two side leaves.

12. The drop-down seal as claimed in claim 11, wherein a front face of the base rail forms a front-face lower stop for the base plates, wherein an edge of the base plates protrudes below the side leaves.

13. The drop-down seal as claimed in claim 11, wherein the angled leaf in the lower region has a shape which forms a counterpart to a region of the inner face of the base rail and, if present, of the end piece, so that the connection between the angled leaf and this region forms an anti-rotational locking.

14. The drop-down seal as claimed in claim 10, wherein the two plates are of identical configuration and form two parts which are separate from one another.

15. The drop-down seal as claimed in claim 11, wherein the two plates are jointly configured in one piece, with one respective base plate and two respective side leaves, wherein the common angled leaf forms the connecting piece between the two plates.
